(19) United States
(12) Patent Application Publication
(10) Pub. No.: US 2025/0244263 A1
(43) Pub. Date: Jul. 31, 2025

(54) METHOD OF QUANTIFYING STATIC AND DYNAMIC ROCK MECHANICAL PROPERTIES

(71) Applicant: Aramco Services Company, Houston, TX (US)

(72) Inventors: Dung T. Phan, Brookshire, TX (US); Hong Phuc Nguyen, Houston, TX (US); Chao Liu, Brookshire, TX (US); Younane N. Abousleiman, Norman, OK (US)

(73) Assignee: Aramco Services Company, Houston, TX (US)

(21) Appl. No.: 18/424,540

(22) Filed: Jan. 26, 2024

(51) Int. Cl. G01N 23/20; E21B 49/02; G01N 9/36; G01N 15/08

(52) U.S. Cl. CPC G01N 23/20; E21B 49/02; G01N 9/36; G01N 15/08; G01N 2223/616; G01N 2223/62

(57) ABSTRACT

A method for obtaining mechanical properties of a rock sample. The method includes measuring a bulk density and a total porosity of the rock sample; identifying mineral phases and measuring volume fractions of the mineral phases relative to total volume of the rock sample; inputting the bulk density, the total porosity, and the volume fractions into a computational model executing on a computing system; processing the data into the computational model; determining static and dynamic mechanical properties of the rock sample; identifying oil and gas reservoir based on the dynamic mechanical properties; estimating reserve of the oil and gas reservoir based on the dynamic mechanical properties of the rock sample; designing effective production strategies for the oil and gas reservoir based on the static mechanical properties; and selecting appropriate drilling tools and hydraulic fracturing operations for the oil and gas reservoir based on the static mechanical properties.

### BACKGROUND

Conventional methods for obtaining static and dynamic mechanical properties of a rock sample are triaxial compression tests which involves several time-consuming steps (e.g., several hours) including sample selection, trimming, smoothening, sealing, axis-aligning, saturation with testing fluid, non-destructive testing method, stress-strain curve analysis. As a result of the labor-intensive, time-consuming, and expensive triaxial tests, very few core samples are measured for dynamic and static properties. Accordingly, there is a need for automation on acquiring static and dynamic mechanical properties of a rock sample from lab measurements of mineral composition, bulk density, and porosity.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for obtaining mechanical properties of a rock sample. The method includes measuring a bulk density of the rock sample; measuring a total porosity of the rock sample; crushing and grinding the rock sample into fine powder; identifying mineral phases and measuring volume fractions of the mineral phases relative to total volume of the rock sample by performing X-ray diffraction (XRD) analysis of the fine powder; inputting measured data of the bulk density, the total porosity, and the volume fractions of the mineral phases into a computational model executing on a computing system; processing the data inputted into the computational model by displaying a main user interface which comprises an input pane, a mineral composition pie chart, and a predicted properties pane; determining static and dynamic mechanical properties of the rock sample based on the processed data; identifying an oil and gas reservoir based on the dynamic mechanical properties of the rock sample; estimating a reserve of the oil and gas reservoir based on the dynamic mechanical properties of the rock sample; designing effective production strategies for the oil and gas reservoir based on the static mechanical properties of the rock sample; and selecting appropriate drilling tools and hydraulic fracturing operations for the oil and gas reservoir based on the static mechanical properties of the rock sample.

In general, in another aspect, embodiments disclosed herein relate to a non-transitory computer readable medium (CRM) storing instructions executable by a computer processor, the instructions include functionality for identifying mineral phases and measuring volume fractions of the mineral phases relative to total volume of a rock sample by performing X-ray diffraction (XRD) analysis of fine powder of the rock sample; inputting measured data of bulk density, total porosity, and volume fractions of the mineral phases into a computational model executing on a computing system; processing the data inputted into the computational model by displaying a main user interface which includes an input pane, a mineral composition pie chart, and a predicted properties pane; determining static and dynamic mechanical properties of the rock sample based on the processed data; identifying an oil and gas reservoir based on the dynamic mechanical properties of the rock sample; estimating a reserve of the oil and gas reservoir based on the dynamic mechanical properties of the rock sample; designing effective production strategies for the oil and gas reservoir based on the static mechanical properties of the rock sample; and selecting appropriate drilling tools and hydraulic fracturing operations for the oil and gas reservoir based on the static mechanical properties of the rock sample.

In general, in yet another aspect, embodiments disclosed herein relate to a system for obtaining mechanical properties of a rock sample. The system includes a total porosity measuring device configured to measure a total porosity of the rock sample; a powder X-ray diffractometer configured to identify mineral phases of a fine powder of the rock sample and to measure volume fractions of the mineral phases relative to total volume of the rock sample; a user input device configured to input measured data bulk density, total porosity, and volume fractions of the mineral phases into a computational model executing on a computing system; the computing system including a processor configured to: process the data inputted into the computational model by displaying a main user interface which includes an input pane, a mineral composition pie chart, and a predicted properties pane; determine static and dynamic mechanical properties of the rock sample based on the processed data; identify an oil and gas reservoir based on the dynamic mechanical properties of the rock sample; estimate a reserve of the oil and gas reservoir based on the dynamic mechanical properties of the rock sample; design effective production strategies for the oil and gas reservoir based on the static mechanical properties of the rock sample; and select appropriate drilling tools and hydraulic fracturing operations for the oil and gas reservoir based on the static mechanical properties of the rock sample.

Other aspects and advantages of the claimed subject matter will be apparent from the following description and the appended claims.

### BRIEF DESCRIPTION OF DRAWINGS

FIG. 1 shows an overview of a system for obtaining the mechanical properties of a rock sample in accordance with one or more embodiments of the disclosure.

FIG. 2 shows an overview of a flowchart of the process for obtaining the mechanical properties of a rock sample in accordance with one or more embodiments of the disclosure.

FIG. 3 shows a flowchart of the process for software computing the mechanical properties of the rock sample from its bulk density, total porosity, and volume fractions of mineral phases in accordance with one or more embodiments of the disclosure.

FIG. 4 illustrates a main user interface of the software in accordance with one or more embodiments of the disclosure.

FIG. 5 illustrates a user interface of the software while selecting a mineral from the dropdown box in accordance with one or more embodiments of the disclosure.

FIG. 6 illustrates a user interface of the software while selecting a rock property from the dropdown list in accordance with one or more embodiments of the disclosure.

FIG. 7 illustrates a user interface of the software while comparing the predictions and the measurements in accordance with one or more embodiments of the disclosure.

FIG. 8A and FIG. 8B show a block diagram of a computing system in accordance with one or more embodiments of the disclosure.

### DETAILED DESCRIPTION

Specific embodiments of the present disclosure will now be described in detail below with reference to the accompanying drawings. Like elements in the various figures are denoted by like reference numerals for consistency.

In the following detailed description of embodiments of the disclosure, numerous specific details are set forth to provide a more thorough understanding of the invention. However, it will be apparent to a person having ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not intended to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

In general, embodiments of the disclosure provide end-users with a simplified and streamlined method for assessing rock mechanical properties that incorporates an advanced computational model for conveniently quantifying static and dynamic rock mechanical properties from lab measurements of mineral composition, bulk density, and porosity.

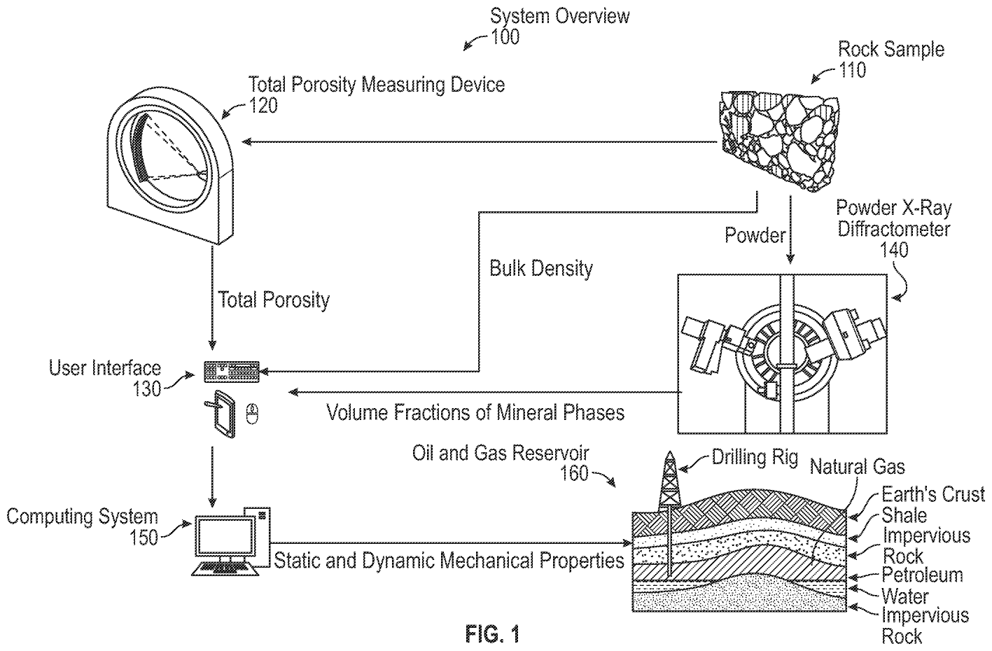

FIG. 1 is an overview of a system for obtaining the mechanical properties of a rock sample in accordance with one or more embodiments of the disclosure. The system 100 comprises a rock sample 110, a total porosity measuring device 120, a user interface 130 electrically connected to the total porosity measuring device 120, a power X-ray diffractometer 140 electrically connected to the user interface 130, and a computing system 150 electrically connected to the user interface 130. Each of these components is subsequently described in detail.

The rock sample 110 is collected from the rock formation of the oil and gas reservoir 160 which may be onshore or offshore. For example, a wellbore may be formed in a subsurface formation of the oil and gas reservoir 160 by rotary drilling. For example, a drill string with a drill bit at its lower end may be suspended within the wellbore. A pump may deliver drilling fluid to the interior of the drill string, causing the drilling fluid to flow downwardly through the drill string. The drilling fluid may exit the drill string via ports in the drill bit, and then may circulate upwardly through the annulus region between the outside of the drill string and the wall of the wellbore. The drilling fluid may carry cuttings up to the surface as the drilling fluid is returned for recirculation. The rock sample 110 from the oil and gas reservoir 160 may be cuttings collected from the drilling fluid that returns from the wellbore. The rock sample 110 (core sample retrieved while drilling or after drilling the well) may be collected and transported to a laboratory for measurements of its mineral composition, its bulk density, and its porosity.

The total porosity measuring device 120 measures the total porosity of the rock sample 110. For example, the total porosity measuring device 120 may be a nuclear magnetic resonance (NMR) device which measures the total porosity of the rock sample 110 by NMR imaging or an X-ray computed tomography (XCT) device which measures the total porosity of the rock sample 110 by XCT scanning.

The user interface 130 electrically connected to the total porosity measuring device 120 and the power X-ray diffractometer 140. Non-limiting examples of the user interface 130 include keyboard, mouse, joystick, data tablet, light pen, trackball, or an optical character reader. The user interface 130 may allow a user to provide data, inputs, and instructions to the computing system 150. For example, through the user interface 130, the user may input the measured data of the bulk density, the total porosity, and the volume fractions of the mineral phases into a computational model executing in the computing system 150.

The power X-ray diffractometer 140 performs an X-ray diffraction (XRD) analysis on the fine powder rock sample 110, obtained by crushing and grinding the rock sample 110 into fine powder, to identify the mineral the phases and to determine the volume fractions of the mineral phases relative to total volume of the rock sample 110.

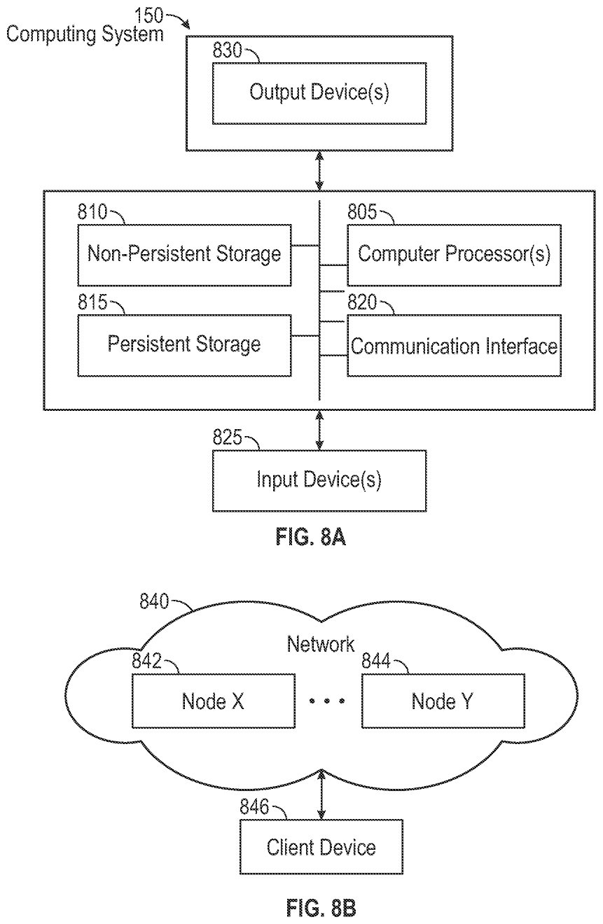

The computing system 150 processes the data inputted into the computational model and determines the static and dynamic mechanical properties of the rock sample 110 based on the processed data. Based on the dynamic mechanical properties of the rock sample 110, the oil and gas reservoir 160 may be identified and its reserve may be estimated. For example, the dynamic mechanical properties of the rock sample 110 may include acoustic velocities to infer vital information about the subsurface of the oil and gas reservoir 160, such as the lithology, the fluid content, and the mechanical properties of rock formations. Based on the static mechanical properties of the rock sample 110, appropriate drilling tools and hydraulic fracturing operations may be selected for the oil and gas reservoir 160. Based on the static mechanical properties of the rock sample 110, effective production strategies for the oil and gas reservoir 160 may be designed. For example, the static mechanical properties of the rock sample 110 may include the Young's modulus and the Poisson's ratio. The static mechanical properties of the rock sample 110 may play a critical role in determining the rock's ability to resist deformation, fracture, and failure during the drilling operation. Understanding these properties may help in selecting the appropriate drilling tools and designing drilling and hydraulic fracturing programs to avoid costly and dangerous issues, such as stuck pipe, lost circulation, or wellbore collapse. For example, knowledge of these properties may influence decisions controlling the drilling mud-weight and when and where to pause drilling to insert and cement casing strings. Each of the components of the computing system 150 is subsequently described in detail in FIG. 8A and FIG. 8B.

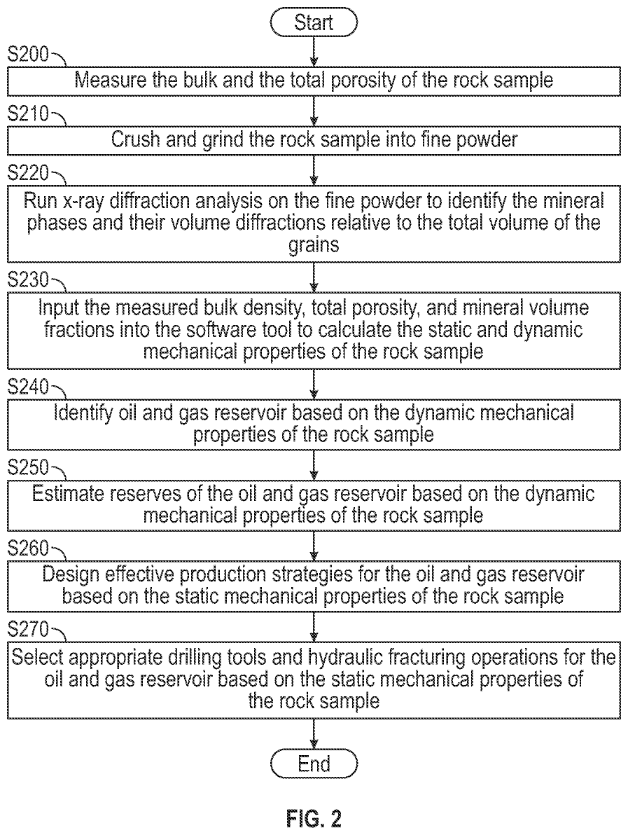

FIG. 2 an overview flowchart of the process for obtaining the mechanical properties of a rock sample in accordance with one or more embodiments of the disclosure. For this process, the rock sample 110 may be divided into a first portion, a second portion, and a third portion. The three portions of the rocks sample are homogenous. The process for obtaining the mechanical properties of the rock sample may be performed by the computer system 150 shown in FIG. 8A. The process includes the steps S200, S210, S220, S230, S240, S250, S260, and S270. Each of these steps is subsequently described in detail.

In step S200, the bulk density and the total porosity of the rock sample 110 may be measured in the laboratory. In the laboratory, the bulk density of the rock sample 150 is obtained by determining the weight of the first portion of the rock sample 110, determining the volume of the first portion of the rock sample 110, and dividing the weight by the volume. Measuring the total porosity of the rock sample 110 includes nuclear magnetic resonance (NMR) imaging or X-ray computed tomography (XCT) scanning on the second portion of the rock sample 110. The total porosity device 120 may include a processor that generates images of the internal structure and features of the rock sample 110.

In step S210, the third portion of the rock sample 110 is crushed and ground into fine powder. That is, each measurement may be made on a separate subsample of the homogenous sample.

In step S220, the X-ray diffraction (XRD) analysis may be run on the fine powder to identify the mineral phases and to measure the volume fractions of the mineral phases relative to total volume of the rock sample. The fine powder that goes through the XRD analysis loses information about the total porosity of the rock sample 110. Therefore, the volume fractions of mineral phases obtained from the XRD analysis are relative to the total volume of the powder (i.e., the grain volume).

In step S230, the measured data of the bulk density, the total porosity, and the volume fractions of the mineral phases are inputted into a computational model (software) executing on a computing system. For example, the software may instantly calculate the static and dynamic mechanical properties of the rock sample 110, instead of going through hours of a single triaxial compression test to determine those properties.

In step S240, the oil and gas reservoir 160 may be identified based on the dynamic mechanical properties of the rock sample 110. The dynamic mechanical properties of the rock sample 110 include acoustic velocities to infer vital information about a subsurface of the oil and gas reservoir 160. The vital information about the subsurface of the oil and gas reservoir 160 includes lithology, fluid content, and mechanical properties of rock formations.

In step S250, the reserves of the oil and gas reservoirs 160 may be estimated based on the dynamic mechanical properties of the rock sample 110.

In step S260, effective production strategies for the oil and gas reservoir may be designed based on the static mechanical properties of the rock sample 110. For example, the static mechanical properties of rocks may include Young's modulus and Poisson's ratio. The static mechanical properties of the rock sample 110 play a critical role in drilling and hydraulic fracturing operations. The critical role may be determining a rock's ability to resist deformation, fracture, and failure during the drilling and hydraulic fracturing operations.

In step S270, appropriate drilling tools and hydraulic fracturing operations for the oil and gas reservoir are selected based on the static mechanical properties of the rock sample 110 to avoid costly and dangerous issues, such as a stuck pipe, a loss of the drilling fluid during recirculation, or a collapse of wellbore. For example, the static mechanical properties of the rock sample 110 may include the Young's modulus and the Poisson's ratio.

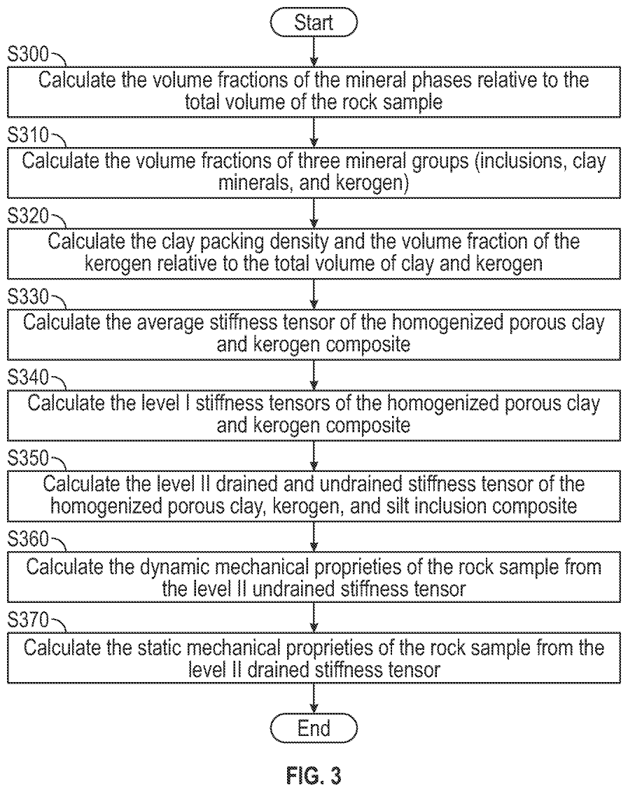

FIG. 3 shows a flowchart of the process for software computing the mechanical properties of the rock sample from its bulk density, total porosity, and volume fractions of mineral phases in accordance with one or more embodiments of the disclosure. The process includes the steps S300, S310, S320, S330, S340, S350, S360, and S370. Each of these steps is subsequently described in detail. Automating these steps in user-friendly software (computational model) enables users of various backgrounds to take advantage of the computational model.

In step S300, the volume fractions of the mineral phases relative to the total volume of the rock sample 110 are calculated by the software. The volume fractions of the mineral phases relative to the total rock sample volume are calculated as follows:

$${v}_{i} = ( 1 - ϕ ) {v}_{i}^{G} \qquad ( 1 )$$

where vᵢ is the volume fraction of the mineral phase i relative to the total rock sample volume, ϕ is the total porosity, and vᵢ^{G} is the volume fraction of the mineral phase i relative to the total grain volume. Hereinafter, the volume fraction refers to the volume fraction relative to the total rock sample volume.

In step S310, the volume fractions of three mineral groups including inclusions, clay minerals, and organic matters (kerogen) are calculated as follows:

$${v}^{i n c} = {\sum }_{i = 1}^{NI} {v}_{i} \qquad ( 2 )$$

$${v}^{c} = {\sum }_{j = 1}^{N C} {v}_{j} \qquad ( 3 )$$

$${v}^{o m} = {\sum }_{k = 1}^{N K} {v}_{k} \qquad ( 4 )$$

where v^{inc} is the total volume fraction of inclusions such as quartz, calcite, pyrite; v^{c} is the total volume fraction of clay minerals such as illite, smectite, kaolinite, chlorite; v^{OM} is the total volume fraction of organic matters; NI is the number of inclusion phases; NC is the number of clay minerals; and NK is the number of organic matters.

In step S320, the clay packing density and the volume fraction of the kerogen relative to the total volume of clay and kerogen are calculated as follows:

$$η = 1 - \frac{ϕ}{1 - {v}^{i n c}} \qquad ( 5 )$$

$${v}^{k} = \frac{{v}^{o m}}{{v}^{c} + {v}^{o m}} \qquad ( 6 )$$

where η is the clay packing density, v^{k} is the volume fraction of organic matters (kerogen) relative to the total volume of clay and kerogen.

In step S330, the average stiffness tensor of the homogenized porous clay and kerogen composite is calculated as follows:

$${ℂ}^{c k} = {ℂ}^{k} + ( 1 - {v}^{k} ) ( {ℂ}^{c} - {ℂ}^{k} ) : \overline{{𝔸}^{s}} \qquad ( 7 )$$

where [symbol] ^{ck} is the average stiffness tensor of the homogenized solid clay particles and kerogen, [symbol] ^{k} is the stiffness tensor of the organic matter phase, [symbol] ^{c} is the stiffness tensor of the clay particles, and [symbol] is the strain concentration tensor averaged over the solid clay particles and kerogen. The strain concentration tensor [symbol] describes the relationship between the macroscopic strain and the local strain in the clay & kerogen particles A^{s} or in the inclusions A^{inc}. The average can be computed, e.g., using Eq 6.151 in the book Microporomechanics. See Eshelby's Problem in Linear Diffusion and Microporoelasticity, p. 193.

In step S340, the level I stiffness tensors of the homogenized porous clay and kerogen composite is calculated as follows:

$${ℂ}^{I} = η {ℂ}^{c k} : \overline{{𝔸}^{s}}$$

where [symbol] ^{I} is the homogenized stiffness tensor of the porous clay and kerogen composite.

In step S350, the level II drained and undrained stiffness tensor of the homogenized porous clay, kerogen, and silt inclusion composite is calculated as follows:

$${ℂ}^{II} = {ℂ}^{I} + {v}^{i n c} ( {ℂ}^{inc} - {ℂ}^{I} ) : \overline{{𝔸}^{inc}} \qquad ( 9 )$$

$${ℂ}^{II , un} = {ℂ}^{II} + {ℳ}^{II} {B}^{II} ⊗ {B}^{II} \qquad ( 10 )$$

where [symbol] ^{II} and [symbol] ^{II,un} are the level II drained and undrained stiffness tensor, respectively, [symbol] ^{inc} is the representative stiffness tensor of inclusion, [symbol] is the strain concentration tensor averaged over the inclusions, [symbol] ^{II} is the Biot modulus, and B^{II} is the Biot coefficient tensor of the rock sample. The Biot modulus [symbol] ^{II} of a porous material relates the variation of fluid content to the increase or decrease of pore pressure. ΔP= [symbol] ^{II}ζ, where ΔP is the pore pressure change, [symbol] ^{II} is the Biot modulus, and ζ is the variation of fluid content, i.e., volume of fluid gained (or lost) per unit volume of the porous material. [symbol] ^{II} and B^{II} are calculated using the following equations:

$$\frac{1}{{ℳ}^{II}} = \frac{1 - {v}^{i n c}}{{ℳ}^{1}} + {v}^{i n c} {B}^{I} : {( {ℂ}^{i n c} - {ℂ}^{I} )}^{- 1} : {B}^{I} : ( 𝕀 - \overline{{𝔸}^{ι n c}} ) \qquad ( 11 )$$

$${B}^{II} = {B}^{I} : ( 𝕀 - {v}^{i n c} \overline{{𝔸}^{ι n c}} ) \qquad ( 12 )$$

$$\frac{1}{{ℳ}^{I}} = 1 : {( {ℂ}^{c k} )}^{- 1} : ( {B}^{I} - ( 1 - η ) 1 ) + \frac{1 - η}{{k}_{f}} \qquad ( 13 )$$

$${B}^{I} = 1 ( 𝕀 - η \overline{{𝔸}^{s}} ) \qquad ( 14 )$$

where k_{f} is the fluid bulk modulus, usually is the value for water k_{f}=2.33 GPa.

In step S360, the dynamic mechanical proprieties of the rock sample from the level II undrained stiffness tensor are calculated as follows:

$$R ( θ ) = \sqrt{{( ( {c}_{11}^{u n} - {c}_{44}^{u n} ) {sin}^{2} θ - ( {c}_{33}^{u n} - {c}_{44}^{u n} ) {cos}^{2} θ )}^{2} + 4 {( {c}_{13} + {c}_{44} )}^{2} {sin}^{2} θ {cos}^{2} θ} \qquad ( 15 )$$

$$Vp ( θ ) = \sqrt{\frac{( {c}_{11}^{u n} + {c}_{44}^{u n} ) {sin}^{2} θ + ( {c}_{33}^{u n} + {c}_{44}^{u n} ) {cos}^{2} θ + R ( θ )}{2 ρ}} \qquad ( 16 )$$

$$Vsh ( θ ) = \sqrt{\frac{{c}_{44}^{u n} + ( {c}_{66}^{u n} - {c}_{44} ) {sin}^{2} θ}{ρ}} \qquad ( 17 )$$

$${Vp}_{1} = Vp ( \frac{π}{2} ) \qquad ( 18 )$$

$${Vp}_{3} = Vp ( 0 ) \qquad ( 19 )$$

$${Vs}_{1} = Vsh ( \frac{π}{2} ) \qquad ( 20 )$$

$${Vs}_{3} = Vsh ( 0 ) \qquad ( 21 )$$

$${E}_{1}^{d} = \frac{ρ V {s}_{1}^{2} ( 3 {Vp}_{1}^{2} - 4 {Vs}_{1}^{2} )}{{Vp}_{1}^{2} - {Vs}_{1}^{2}} \qquad ( 22 )$$

$${E}_{3}^{d} = \frac{ρ {Vs}_{3}^{2} ( 3 {Vp}_{3}^{2} - 4 {Vs}_{3}^{2} )}{{Vp}_{3}^{2} - {Vs}_{3}^{2}} \qquad ( 23 )$$

$${v}_{1}^{d} = \frac{{( \frac{{Vp}_{1}}{{Vs}_{1}} )}^{2} - 2}{2 {( \frac{{Vp}_{1}}{{Vs}_{1}} )}^{2} - 2} \qquad ( 24 )$$

$${v}_{3}^{d} = \frac{{( \frac{{Vp}_{3}}{{Vs}_{3}} )}^{2} - 2}{2 {( \frac{{Vp}_{3}}{{Vs}_{3}} )}^{2} - 2} \qquad ( 25 )$$

$${G}^{d} = ρ V {s}_{1}^{2} \qquad ( 26 )$$

where:
ρ is the bulk density,
Vp₁ is the P-Wave velocity propagated parallel to lamination,
Vp₃ is the P-Wave velocity propagated normal to lamination,
Vs₁ is the S-Wave velocity propagated parallel to lamination,
Vs₃ is the S-Wave velocity propagated normal to lamination,
E₁^{d} is the dynamic Young's modulus parallel to lamination,
E₃^{d} dynamic Young's modulus normal to lamination,
v₁^{d} is the dynamic Poisson's ratio parallel to lamination,
v₃^{d} is the dynamic Poisson's ratio normal to lamination,
G^{d} is the dynamic shear modulus, and
cᵢⱼ^{un} are the components of the level II undrained stiffness tensor [symbol] ^{II,un}.

In step S370, the static mechanical proprieties of the rock sample from the level II drained stiffness tensor are calculated as follows:

$${E}_{1} = \frac{( {c}_{11} - {c}_{12} ) ( {c}_{11} {c}_{33} + {c}_{12} {c}_{33} - 2 {c}_{13}^{2} )}{{c}_{11} {c}_{33} - {c}_{13}^{2}} \qquad ( 27 )$$

$${E}_{3} = {c}_{33} - \frac{2 {c}_{13}^{2}}{{c}_{11} + {c}_{12}} \qquad ( 28 )$$

$${v}_{1} = \frac{{c}_{12} {c}_{33} - {c}_{13}^{2}}{{c}_{11} {c}_{33} - {c}_{13}^{2}} \qquad ( 29 )$$

$${v}_{3} = \frac{{c}_{13}}{{c}_{11} + {c}_{12}} \qquad ( 30 )$$

$$G = {c}_{66} \qquad ( 31 )$$

where:
E₁ is the static Young's modulus parallel to lamination,
E₃ is the static Young's modulus normal to lamination,
v₁ is the static Poisson's ratio parallel to lamination,
v₃ is the static Poisson's ratio normal to lamination,
G is the static shear modulus, and
cᵢⱼ are the components of the level II drained stiffness tensor [symbol] ^{II}.

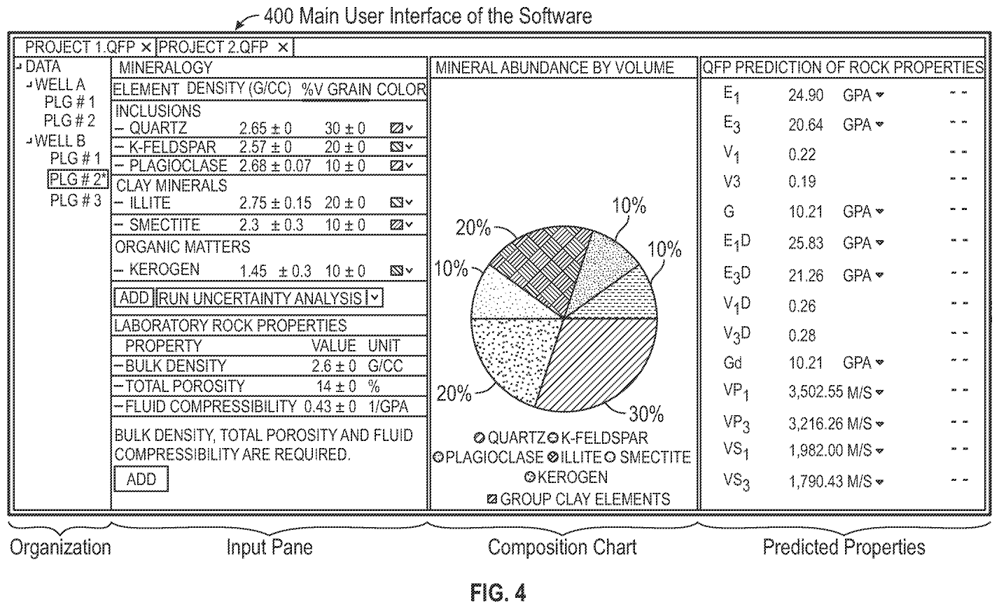

FIG. 4 illustrates a main user interface of the software in accordance with one or more embodiments of the disclosure. The software provides a simple yet powerful interface, allowing the user to perform all tasks on a single screen. The main user interface 400 includes an input pane, a mineral composition pie chart, and a predicted properties pane. The input pane includes minerology data and laboratory rock properties. The minerology data include inclusions, clay minerals, and organic matters. The laboratory rock properties include the bulk density and the total porosity. The mineral composition pie chart indicates mineral abundance by volume. The predicted properties pane is a quartz, feldspar, and pyrite (QFP) prediction of rock properties pane. The static and dynamic mechanical properties of the rock sample 110 is displayed in the QFP prediction of rock properties pane.

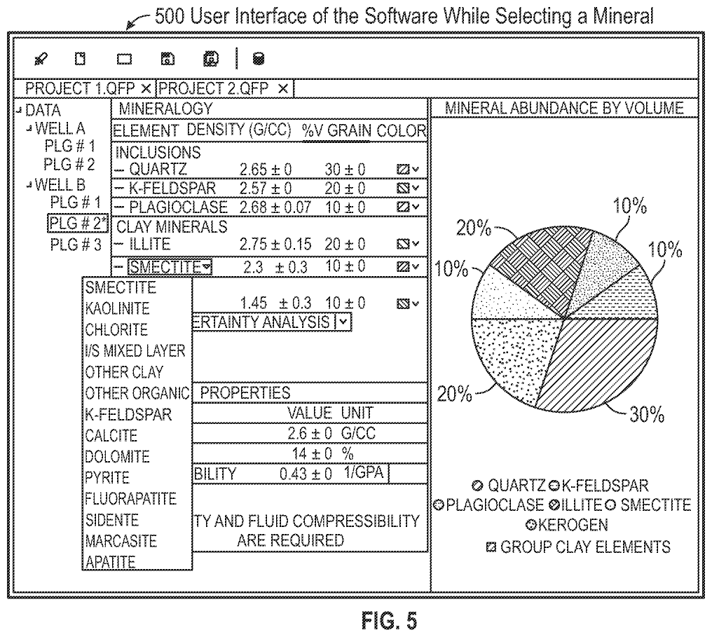

The software allows the user to work on multiple projects, each contained in one tab. In each project, the user may organize the data into wells with each well containing multiple rock samples. See the tree structure on the left-most pane in FIG. 4. For each rock sample, the user may enter the mineral phase data into a mineralogy grid. The procedure to enter a mineral phase is as follows:
click the Add button,
select a mineral name from the dropdown box as shown in FIG. 5, and
enter the fraction/percentage of the mineral weight/volume in the rock sample.

The mineral composition pie chart is automatically updated when there are changes in the inputs. The user enters the bulk density and total porosity in the laboratory rock properties grid. The software automatically displays the rock's dynamic and static mechanical properties in the QFP prediction of rock properties pane. The 14 dynamic and static mechanical properties predicted by the software are E₁, E₃, v₁, v₃, G, E₁^{d}, E₃^{d}, v₁^{d}, v₃^{d}, G^{d}, Vp₁, Vp₃, Vs₁, and Vs₃.

FIG. 5 illustrates a user interface of the software while selecting a mineral from the dropdown box in accordance with one or more embodiments of the disclosure. For example, the user interface 500 shows that the minerals selected from the dropdown box are quartz, k-feldspar, plagioclase, illite, smectite, and kerogen based on the mineral composition pie chart which is automatically updated when there are changes in the inputs.

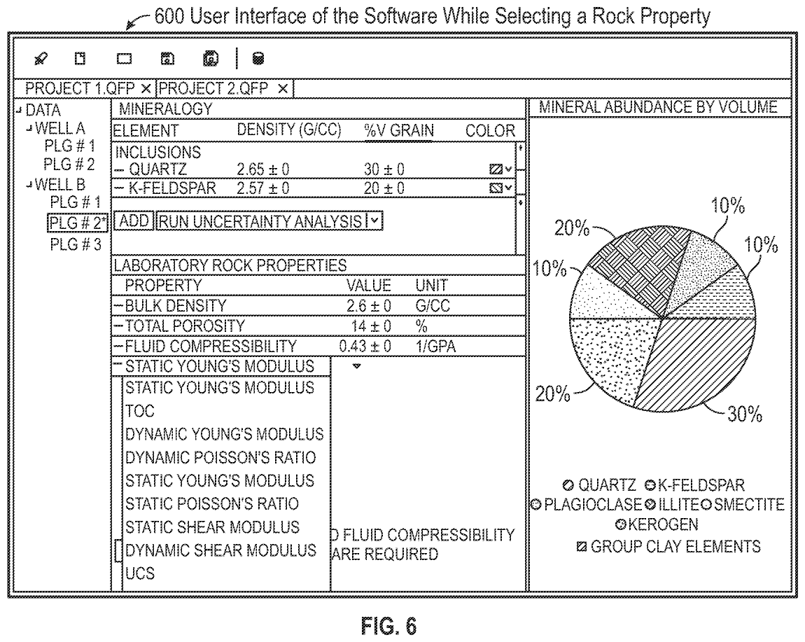

FIG. 6 illustrates a user interface of the software while selecting a rock property from the dropdown list in accordance with one or more embodiments of the disclosure. For example, the rock property that may selected from the dropdown list includes bulk density, total porosity, fluid compressibility, static Young's modulus, dynamic Young's modulus, dynamic Poisson's ratio, static Poisson's ratio, dynamic Shear's modulus, and static Shear's modulus.

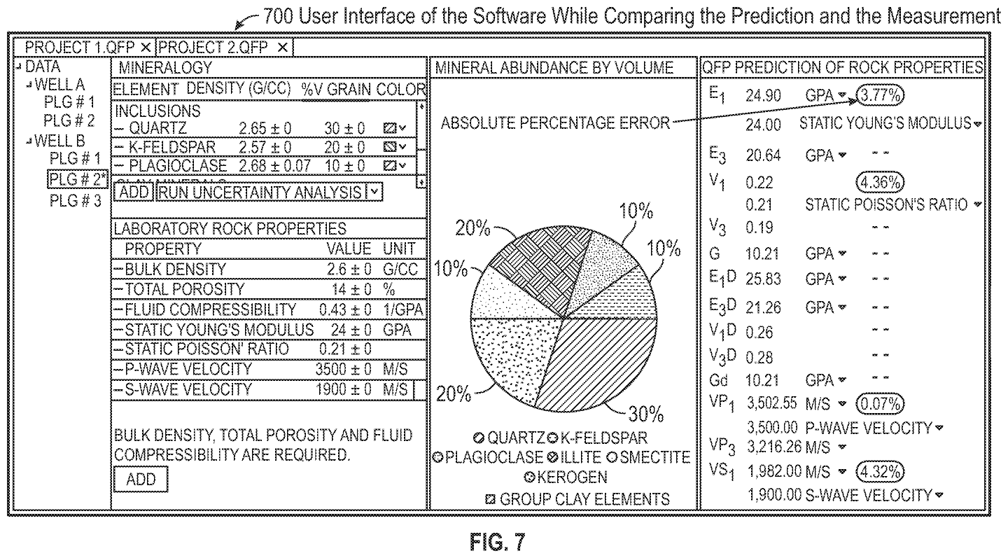

FIG. 7 illustrates a user interface of the software while comparing the predictions and the measurements in accordance with one or more embodiments of the disclosure. The software allows the user to compare the predicted mechanical properties with the actual measurements. This feature is useful for verification of the prediction model. To add a lab measurement, the user may click on the add button below the laboratory rock properties pane. Next, the user may select the rock property measured in the dropdown list, as shown in FIG. 6. Next, the user may enter the measured value and unit for the property. After that, in the QFP prediction of the rock properties pane, the user may select the measured rock property to compare with the prediction. The software automatically converts the unit entered in the laboratory rock properties pane to match the unit the user selected in the QFP Prediction of rock properties. In addition, the absolute percentage error (APE) is automatically calculated and displayed to aid the comparison, as shown in FIG. 7. The APE also conveniently serves as a toggle button to show/hide the rock property measurement.

The software allows the user to quantify the uncertainties in the model prediction of rock properties due to the uncertainties in the input data. This feature is especially helpful as laboratory measurements of mineralogy, bulk density, and total porosity can have some uncertainties. The uncertainties may be entered along with any input such as mineralogy data.

After inputting the uncertainties, the user may click on the run uncertainty analysis button to get the results with the default parameters. If the user wants to change the parameters, the user may expand the button to do so. For example, the user may change the number of samples and the input uncertainty distribution used in Monte-Carlo uncertainty analysis. A normal distribution means that an input a±b is interpreted as a normal distribution with mean a and standard deviation b. A uniform distribution means that an input a±b is interpreted as a uniform distribution in the range [a−b, a+b].

The uncertainty analysis results are presented in the QFP prediction of rock properties pane. Each predicted rock property distribution is plotted, and its distribution parameters are displayed, e.g., E₁˜N(μ, σ²) means the Young's modulus parallel to lamination is normally distributed with mean μ and standard deviation σ.

The software has several convenient features. For example, the software has 6 modes for specifying the mineral abundance such as weight percentage (% Wt), volume percentage relative to the total grain volume that excludes porosity (% V Grain), volume percentage relative to the total volume that includes porosity (% V Total), weight fraction (Wt/Wt), volume fraction relative to the total grain volume that excludes porosity (V/V Grain), and volume fraction relative to the total volume that excludes porosity (V/V Total). For example, the software allows the user to manage (add, modify, delete) the mineral definition database and the rock property definition database. When the user clicks on the database icon on the toolbar, the database management interface shows up.

FIG. 8A and FIG. 8B show a block diagram of a computing system in accordance with one or more embodiments of the disclosure. The process for obtaining the bulk density, the total porosity, the mineral composition, and the mechanical properties of the rock sample may be performed in the computing system 150, as shown in FIG. 8A and FIG. 8B. Any combination of mobile, desktop, server, router, switch, embedded device, or other types of hardware may be used. For example, the computing system 150 may include one or more computer processor(s) 805, a non-persistent storage 810 (e.g., volatile memory, such as random access memory (RAM), cache memory), a persistent storage 815 (e.g., a hard disk, an optical drive such as a compact disk (CD) drive or digital versatile disk (DVD) drive, a flash memory, etc.), a communication interface 820 (e.g., Bluetooth interface, infrared interface, network interface, optical interface, etc.), and numerous other elements and functionalities.

The computer processor(s) 805 may be an integrated circuit for processing instructions. For example, the computer processor(s) 805 may be one or more cores or micro-cores of a processor. The computing system 150 may also include one or more input device(s) 825, such as a touchscreen, keyboard, mouse, microphone, touchpad, electronic pen, or any other type of input device.

The communication interface 820 may include an integrated circuit for connecting the computing system 150 to a network (not shown) (e.g., a local area network (LAN), a wide area network (WAN) such as the Internet, mobile network, or any other type of network) and/or to another device, such as another computing device.

The computing system 150 may further includes one or more output device(s) 830, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input device(s) 825 and the output device(s) 830 may be locally or remotely connected to the computer processor(s) 805, the non-persistent storage 810, and the persistent storage 815. Many different types of computing systems exist, and the aforementioned input device(s) 825 and output device(s) 830 may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system 150 in FIG. 8A may be connected to or be a part of a network. For example, as shown in FIG. 8B, the network 840 may include multiple nodes (e.g., node X 842, node Y 844). Each node may correspond to a computing system, such as the computing system shown in FIG. 8A, or a group of nodes combined may correspond to the computing system shown in FIG. 8A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system 150 may be located at a remote location and connected to the other elements over a network.

Although not shown in FIG. 8B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X 842, node Y 844) in the network 840 may be configured to provide services for a client device 846. For example, the nodes may be part of a cloud computing system. The nodes may include functionality to receive requests from the client device 846 and transmit responses to the client device 846. The client device 846 may be a computing system, such as the computing system shown in FIG. 8A. Further, the client device 846 may include and/or perform all or a portion of one or more embodiments of the disclosure.

The computing system or group of computing systems described in FIG. 8A and FIG. 8B may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may be executed on the same or different computing system.

Rather than or in addition to sharing data between processes, the computing system 150 performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor(s) 805. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system 150, in performing one or more embodiments of the disclosure, may extract one or more data items from the obtained data. For example, the extraction may be performed as follows by the computing system 150 in FIG. 8A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system 150 of FIG. 8A, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 8A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system 150 of FIG. 8A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system 150 of FIG. 8A and the nodes and/or client device 846 in FIG. 8B. Other functions may be performed using one or more embodiments of the disclosure.

Embodiments of the present disclosure may provide at least one of the following advantages. Embodiments of the disclosure may allow obtaining the rock sample dynamic and static mechanical properties through laboratory measurements performed on core samples retrieved from a well.

Embodiments of the present disclosure may avoid labor-intensive, cumbersome equipment and time-consuming procedures of the triaxial compression tests which result in very few core samples being measured for dynamic and static properties.

Embodiments of the present disclosure may determine the petrophysical properties, such as bulk density and porosity, and the mineral composition of a rock sample through laboratory measurements which are relatively simpler and faster. For instance, to determine the mineral composition via an XRD test, only 5 grams of finely ground sample are required, and it takes as little as 15-20 minutes. This means that even defective samples and rock chips that are not suitable for triaxial tests are acceptable for these tests. Consequently, there are significantly more rock samples with petrophysical and XRD data available compared to those with mechanical measurements. That means geoscientists know more about petrophysical and mineralogy at different depths than they do about rock mechanical properties. It would be ideal to use petrophysical and mineralogy data to fill in the gaps for mechanical properties.

Embodiments of the present disclosure may provide end-users with a simplified and streamlined method for assessing rock mechanical properties that incorporates an advanced computational model for conveniently quantifying static and dynamic rock mechanical properties from lab measurements of mineral composition, bulk density, and porosity.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for obtaining mechanical properties of a rock sample, the method comprising:
measuring a bulk density of the rock sample;
measuring a total porosity of the rock sample;
crushing and grinding the rock sample into fine powder;
identifying mineral phases and measuring volume fractions of the mineral phases relative to total volume of the rock sample by performing X-ray diffraction (XRD) analysis of the fine powder;
inputting measured data of the bulk density, the total porosity, and the volume fractions of the mineral phases into a computational model executing on a computing system;
processing the data inputted into the computational model by displaying a main user interface which comprises an input pane, a mineral composition pie chart, and a predicted properties pane;
determining static and dynamic mechanical properties of the rock sample based on the processed data;
identifying an oil and gas reservoir based on the dynamic mechanical properties of the rock sample;
estimating a reserve of the oil and gas reservoir based on the dynamic mechanical properties of the rock sample;
designing effective production strategies for the oil and gas reservoir based on the static mechanical properties of the rock sample; and
selecting appropriate drilling tools and hydraulic fracturing operations for the oil and gas reservoir based on the static mechanical properties of the rock sample.

2. The method according to claim 1, wherein the dynamic mechanical properties of rock sample include acoustic velocities to infer lithology, fluid content, and mechanical properties of rock formations of a subsurface of the oil and gas reservoir.

3. The method according to claim 1, wherein performing the XRD analysis includes:
calculating the volume fractions of three mineral groups including inclusions, clay minerals, and kerogen; and calculating a clay packing density and a volume fraction of kerogen relative to a total volume of clay and kerogen.

4. The method according to claim 3, further comprises:
calculating an average stiffness tensor of a homogenized solid clay and kerogen fabric; calculating a level I stiffness tensor of a homogenized porous clay and kerogen composite;
calculating dynamic mechanical properties of the rock sample from a level II undrained stiffness tensor; and
calculating static mechanical properties of the rock sample from a level II drained stiffness tensor.

5. The method according to claim 1, wherein the input pane includes:
minerology data of inclusions, clay minerals, and organic matters; and
laboratory rock properties including the bulk density of the rock sample and the total porosity of the rock sample.

6. The method according to claim 1, wherein the mineral composition pie chart indicates mineral abundance by volume.

7. The method according to claim 1, wherein the predicted properties pane is a quartz, feldspar, and pyrite (QFP) prediction of rock properties pane which displays the static and dynamic mechanical properties of the rock sample.

8. A non-transitory computer readable medium (CRM) storing instructions executable by a computer processor, the instructions comprising functionality for:
identifying mineral phases and measuring volume fractions of the mineral phases relative to total volume of a rock sample by performing X-ray diffraction (XRD) analysis of fine powder of the rock sample;
inputting measured data of bulk density, total porosity, and volume fractions of the mineral phases into a computational model executing on a computing system;
processing the data inputted into the computational model by displaying a main user interface which includes an input pane, a mineral composition pie chart, and a predicted properties pane;
determining static and dynamic mechanical properties of the rock sample based on the processed data;
identifying an oil and gas reservoir based on the dynamic mechanical properties of the rock sample;
estimating a reserve of the oil and gas reservoir based on the dynamic mechanical properties of the rock sample;
designing effective production strategies for the oil and gas reservoir based on the static mechanical properties of the rock sample; and
selecting appropriate drilling tools and hydraulic fracturing operations for the oil and gas reservoir based on the static mechanical properties of the rock sample.

9. The non-transitory CRM according to claim 8, wherein the dynamic mechanical properties of rock sample include acoustic velocities to infer lithology, fluid content, and mechanical properties of rock formations of a subsurface of the oil and gas reservoir.

10. The non-transitory CRM according to claim 8, wherein performing the XRD analysis includes:
calculating the volume fractions of three mineral groups including inclusions, clay minerals, and kerogen; and calculating a clay packing density and a volume fraction of kerogen relative to a total volume of clay and kerogen.

11. The non-transitory CRM according to claim 10, further comprises:
calculating an average stiffness tensor of a homogenized solid clay and kerogen fabric; calculating a level I stiffness tensor of a homogenized porous clay and kerogen composite;
calculating dynamic mechanical properties of the rock sample from a level II undrained stiffness tensor; and
calculating static mechanical properties of the rock sample from a level II drained stiffness tensor.

12. The non-transitory CRM according to claim 8, wherein the input pane includes:
minerology data of inclusions, clay minerals, and organic matters; and
laboratory rock properties including the bulk density of the rock sample and the total porosity of the rock sample.

13. The non-transitory CRM according to claim 8, wherein the mineral composition pie chart indicates mineral abundance by volume.

14. The non-transitory CRM according to claim 8, wherein the predicted properties pane is a quartz, feldspar, and pyrite (QFP) prediction of rock properties pane which displays the static and dynamic mechanical properties of the rock sample.

15. A system for obtaining mechanical properties of a rock sample, the system comprising:
a total porosity measuring device configured to measure a total porosity of the rock sample;
a powder X-ray diffractometer configured to identify mineral phases of a fine powder of the rock sample and to measure volume fractions of the mineral phases relative to total volume of the rock sample;
a user input device configured to input measured data bulk density, total porosity, and volume fractions of the mineral phases into a computational model executing on a computing system;
the computing system including a processor configured to:
process the data inputted into the computational model by displaying a main user interface which includes an input pane, a mineral composition pie chart, and a predicted properties pane;
determine static and dynamic mechanical properties of the rock sample based on the processed data;
identify an oil and gas reservoir based on the dynamic mechanical properties of the rock sample;
estimate a reserve of the oil and gas reservoir based on the dynamic mechanical properties of the rock sample;
design effective production strategies for the oil and gas reservoir based on the static mechanical properties of the rock sample; and
select appropriate drilling tools and hydraulic fracturing operations for the oil and gas reservoir based on the static mechanical properties of the rock sample.

16. The system according to claim 15, wherein the dynamic mechanical properties of rock sample include acoustic velocities to infer lithology, fluid content, and mechanical properties of rock formations of a subsurface of the oil and gas reservoir.

17. The system according to claim 15, wherein the powder X-ray diffractometer further:
calculate the volume fractions of three mineral groups including inclusions, clay minerals, and kerogen; and
calculate a clay packing density and a volume fraction of kerogen relative to a total volume of clay and kerogen.

18. The system according to claim 15, wherein the input pane includes:
minerology data of inclusions, clay minerals, and organic matters; and
laboratory rock properties including the bulk density of the rock sample and the total porosity of the rock sample.

19. The system according to claim 15, wherein the mineral composition pie chart indicates mineral abundance by volume.

20. The system according to claim 15, wherein the predicted properties pane is a quartz, feldspar, and pyrite (QFP) prediction of rock properties pane which displays the static and dynamic mechanical properties of the rock sample.
